(19) United States
(12) Patent Application Publication
(10) Pub. No.: US 2025/0100455 A1
(43) Pub. Date: Mar. 27, 2025

(54) VEHICLE BODY, VEHICLE INTERIOR FITTING AND MOTOR VEHICLE

(71) Applicants: Bott GmbH & Co. KG, Gaildorf (DE); Snoeks Automotive B.V., NC Nieuw-Vennep (NL)

(72) Inventors: Jan-Willem Jongert, Gaildorf (DE); Marc Broere, NC Nieuw-Vennep (NL)

(73) Assignees: Bott GmbH & Co. KG, Gaildorf (DE); Snoeks Automotive B.V., NC Nieuw-Vennep (NL)

(21) Appl. No.: 18/886,799

(22) Filed: Sep. 16, 2024

(30) Foreign Application Priority Data
Sep. 22, 2023 (DE) 102023125763.3

(51) Int. Cl. B60R 5/00

(52) U.S. Cl. CPC B60R 5/003

(57) ABSTRACT

The invention relates to a vehicle body having a loading space, a driver's cab, a partition wall and a rack unit. The loading space and the driver's cab are separated from one another by the partition wall. The rack unit is arranged in the loading space and extends, adjacently to the separating wall, transversely to a longitudinal axis of the vehicle body. The partition wall and the rack unit have a common supporting frame, which is fixed to at least one pillar of the vehicle body directly and/or via fastening profiles.

### CROSS-REFERENCE TO RELATED APPLICATION

The present Application for Patent claims priority of German Patent Application No. 10 2023 125 763.3, entitled “Vehicle body, vehicle interior fitting and motor vehicle,” filed Sep. 22, 2023, assigned to the assignee hereof, the contents of which are incorporated herein by reference in their entirety and for all proper purposes.

### DESCRIPTION

The disclosure relates to a vehicle body having a loading space, a driver's cab, a partition wall and a rack unit, the loading space and the driver's cab being separated from one another by the partition wall, and the rack unit being arranged in the loading space and extending adjacently to the partition wall, transversely to a longitudinal axis of the vehicle body.

The disclosure also relates to a vehicle interior fitting which is suitable for separating a loading space and a driver's cab of a motor vehicle from one another and has a rack unit, which extends adjacently to the partition wall.

Vehicle bodies having a loading space and a driver's cab, in the case of which vehicle bodies the loading space and the driver's cab are separated from one another by a partition wall, are known from the general prior art. It is also known that such vehicle bodies have a rack unit, or a rack unit which is positioned in the loading space adjacently to, or next to, the partition wall and extends transversely to a longitudinal axis of the vehicle body is assembled. A challenge in this respect is the fixing both of the partition wall and of the rack unit to the vehicle body. The general intention is to fix the partition wall and the rack unit to the B pillars of the vehicle body, but these pillars do not provide much space for this.

A motor vehicle having a rack in the loading space is known from DE 10 2021 133 322 A1. In this case, the driver's cab is separated from the loading space by a partition wall, which forwardly delimits the loading space in the direction of the vehicle longitudinal axis. Such partition walls typically separate the driver's cab from the loading space completely. One or more rack units, in which objects can be stored, may be arranged in the loading space. Such motor vehicles may be used for example to deliver goods, with packages being stored in the rack units for this purpose. In another use example, the motor vehicle may be used by craftspeople or service providers. In this case, the rack system may be designed to store e.g. tools, toolboxes, equipment or building materials.

It is known from the general prior art that rack units in the loading space of motor vehicles may be arranged with an extent both in the longitudinal direction of the motor vehicle, which is to say parallel to a vehicle longitudinal axis, and transversely thereto. Rack units arranged transversely to the vehicle longitudinal axis frequently extend adjacently to and parallel to the partition wall.

A partition wall for a motor vehicle is also known from DE 197 51 671 B4. That document describes that a partition wall separates a driver's compartment from a useful space of the vehicle and is as a result intended to prevent objects accommodated or transported in the useful space from entering the driver's compartment. In this way, the intention is to effectively increase both the driving safety and the safety for the driver and a front-seat passenger in the event of an accident. In order to be able to ensure such protection, a partition wall of this type usually starts on the vehicle floor and extends substantially vertically upward along the back side of the seats of the driver's compartment or the driver's cab. The partition wall delimits the length of the useful space or the loading space in the vehicle longitudinal direction. The useful space therefore generally ends in the region of the back side of the seats of the driver's compartment. To fasten the partition wall, DE 197 51 671 B4 proposes welding it to the B pillar of the vehicle.

As regards the further prior art, reference is also made to DE 10 2009 050 065 A1, which also describes a motor vehicle having a partition wall between a rear space and a front space of a passenger compartment. In this case, the intention is also to fasten the partition wall to a B pillar of the motor vehicle.

A rack system or a vehicle interior fitting for a utility vehicle is known from the applicant's DE 10 2019 116 078 A1.

To optimally utilize the loading space, in some embodiments, a rack unit is arranged or fixed extending adjacently to and parallel to the partition wall. In this case, the rack unit extends from the vehicle floor, over the available height of the interior space of the vehicle body or of the utility vehicle, and as far as possible also over the entire width of the interior space. Rack units of this type should be fixed stably and securely to the vehicle body. For this purpose, the rack unit extends transversely to the vehicle longitudinal axis is fixed to vehicle pillars at both of its ends. In this case, the vehicle pillars are the B pillars of the motor vehicle. A disadvantage of this is that the partition wall is also fixed to the B pillars of the motor vehicle, since a stable and firm connection to the vehicle body is also desirable in this case. The fixing both of the partition wall and of the rack unit extending transversely to the vehicle longitudinal axis makes the assembly more difficult, or can result in it being necessary to use fastening holes or anchor points in the B pillars both for the partition wall and for the rack unit.

The disclosure is based on the object of providing a vehicle body having a loading space and a driver's cab, in the case of which vehicle body the partition wall and the rack unit are arranged optimally, in particular such that they can be assembled more easily.

This object is achieved according to the disclosure by the features of the claims and accompanying description.

The disclosure is also based on the object of providing a vehicle interior fitting which can be arranged optimally and can be assembled securely and easily.

The disclosure is furthermore based on the object of providing an improved motor vehicle, in particular an improved utility vehicle, having a partition wall between a driver's cab and a loading space and having a rack unit in the loading space.

The vehicle body according to the disclosure has a loading space, a driver's cab, a partition wall and a rack unit, the loading space and the driver's cab being separated from one another by the partition wall. The rack unit is arranged in the loading space and extends adjacently to the separating wall, transversely to a longitudinal axis of the vehicle body. The disclosure provides that the partition wall and the rack unit have a common supporting frame, which is fixed to at least one pillar of the vehicle body directly and/or via fastening profiles.

Since the partition wall and the rack unit have a common supporting frame, they can be fixed to at least one pillar of the vehicle body considerably easier compared with the prior art. Compared with the prior art, in which the partition wall and the rack unit were in the form of independent, self-supporting elements which each needed to be fastened to the pillar of the motor vehicle, as a result of which corresponding space or attachment problems arose, the solution according to the disclosure now affords both considerably easier assembly and a saving on weight, since the partition wall and the rack unit now use a common supporting frame.

The partition wall and the rack unit thus use a common supporting frame which is or can be fixed to at least one pillar of the motor vehicle without space problems or without needing to apportion attachment points, for example fastening holes.

The solution according to the disclosure moreover also still saves on structural space, as a result of which the loading space and/or the driver's cab correspondingly gain space, without adversely affecting the stability.

An assembly method can provide that firstly the supporting frame is fixed to at least one pillar of the vehicle body. The further elements of the partition wall and of the rack unit can then be assembled on the supporting frame. In addition to making the assembly easier in that only one supporting frame is fixed to the at least one pillar of the motor vehicle, the assembly complexity is also simplified in that the assembly can be completed in one activity. In the prior art, it was conventional firstly for the partition wall to be assembled, usually at the vehicle manufacturer. The rack unit is typically assembled in the loading space only later on, and usually also not at the vehicle manufacturer, during the installation of the vehicle interior fitting, in particular a rack system, which also has yet further rack units in addition to the rack unit in the rack. For this, it was to some extent necessary to detach the partition wall again in order to be able to reach fastening holes/anchoring points on the pillar of the vehicle body. Now, it is not necessary to assemble the partition wall and the rack unit at different times and/or in different places, as a result of which the assembly method is also facilitated.

In some embodiments, the partition wall at least approximately completely separates or splits up the loading space and the driver's cab, which is to say that the partition wall extends at least approximately over the entire height of an interior space of the vehicle body in this region, which is to say in the region between the driver's cab and the loading space, and/or that the partition wall extends from the vehicle floor at least over the entire width of the interior space in this region.

Within the context of the disclosure, it is provided that the partition wall at least approximately completely separates or shuts off the driver's cab from the loading space. The partition wall is intended to shut off or separate the loading space and the driver's cab from one another. It may be provided that ventilation slots or ventilation openings enabling an exchange of air are present. What is essential is that objects stored in the loading space cannot pass from the loading space into the driver's cab, in particular even in the event of an accident.

The partition wall may optionally have a window and/or a door, in this case it being possible to provide that the rack unit is adapted to the presence of a window and/or a door, so that there is no rack unit in the region.

The partition wall does not have a window or a door.

Within the context of the disclosure, it is provided that the rack unit is arranged on that side of the partition wall that faces away from the driver's cab. The rack unit can thus be accessed from the loading space.

It should be noted that, within the context of the disclosure, the expression “supporting frame” should not be understood as meaning that it has to be in the form of a peripheral or closed frame.

According to the disclosure, the supporting frame can be in the form of a peripheral frame. The supporting frame can be constructed easily and stably, however in the context of the disclosure such an embodiment of the supporting frame is not absolutely necessary. The supporting frame may in particular also be U-shaped or in the form of a U frame, or be L-shaped or in the form of an L frame, or else have only two mutually parallel frame parts, and/or two frame parts which each extend adjacently to a pillar of the vehicle body in a vertical direction.

Within the context of the disclosure, the expression “supporting frame” is to be understood such that it is not formed in one piece, or is not in the form of a one-piece component of the vehicle body or of the pillar of the vehicle body, but that the supporting frame is in the form of part of the partition wall and the rack unit independently of the vehicle body and is or can be fixed to the pillar of the vehicle body.

Within the context of the disclosure, the expression “pillar of the vehicle body” is to be understood as meaning a vertically extending pillar of the vehicle body.

The supporting frame may be force-fittingly and/or form-fittingly connected to the at least one pillar. An integral bond may also be provided.

The disclosure may provide that the supporting frame is detachably fixed to the at least one pillar.

Fixing the supporting frame detachably, such as by screw-fastening, has been found to be suitable. The supporting frame may, however, also be welded or riveted or adhesively bonded to the pillar. Mixtures of the aforementioned fastening types are also conceivable. As an alternative to a detachable connection, a conditionally detachable connection may also be used.

Within the context of the disclosure, it may be provided that the partition wall and the rack unit are connected or fixed to the vehicle body only via the supporting frame. However, it may additionally also be provided that the partition wall and/or the rack unit is fixed to the vehicle body directly or via connecting elements. It may in particular be provided that an upper region of the partition wall is additionally fixed to a roof of the vehicle body or a roof strut of the vehicle body. This can further increase the stability of the partition wall, in particular a cladding of the partition wall. With preference, neither the partition wall nor the rack unit is connected to the vertically extending pillars of the vehicle body directly or via connecting elements.

Within the context of the disclosure, it may be provided that the supporting frame is fixed to at least one pillar of the vehicle body directly. However, the intention may also be to provide fastening profiles for the connection between the supporting frame and the at least one pillar of the vehicle body, which is to say that the supporting frame is fixed to at least one pillar of the vehicle body by means of or via fastening profiles. This can be suitable in particular in order to vary the position of the supporting frame, as viewed in the longitudinal direction of the vehicle body, in order to make the assembly easier.

The disclosure may provide that the supporting frame is fixed to two pillars of the vehicle body which are provided on oppositely situated longitudinal sides of the vehicle body.

In some embodiments, the supporting frame is fixed to two pillars, such as to exactly two pillars, of the vehicle body. The pillars to which the supporting frame is fixed may be two pillars which are on oppositely situated longitudinal sides of the vehicle body and at identical longitudinal positions with respect to the longitudinal axis of the vehicle body.

In some embodiments, the at least one pillar is a B pillar of the vehicle body.

Fastening the supporting frame to the two B pillars of the vehicle body has been found to be suitable, with the result that the partition wall brings about separation between the loading space and the driver's cab and the rack unit is also optimally positioned.

The disclosure may provide that a cladding, which separates the loading space and the driver's cab from one another, of the partition wall is fixed to the supporting frame directly and/or via profile elements, and at least one module of the rack unit is fixed to the supporting frame directly and/or via profile elements.

In some embodiments, a cladding, which separates the loading space and the driver's cab from one another, of the partition wall is fixed to the supporting frame. It has also been found to be suitable if at least one module, or multiple modules, of the rack unit is or are fixed to the supporting frame.

The cladding of the partition wall and/or the at least one module can be fastened to the supporting frame directly or via profile elements, which in particular can be used to establish distances between the cladding or the module and the supporting frame.

The profile elements may consist of plastic or metal.

It may be provided that the cladding of the partition wall is additionally connected to the vehicle floor and/or a roof of the vehicle body, in particular a roof strut of the vehicle body, or fixed there.

In some embodiments, the at least one module is in the form of a drawer, box, tray, shelf, worktop, wall cladding, wall cabinet, tool cabinet, slotted plate, perforated plate, or receptacle for a toolbox.

The aforementioned forms of the module have been found to be suitable for equipping a rack unit, in particular for tradespeople.

In some embodiments, multiple slotted plates and/or perforated plates and multiple drawers and/or shelves and/or boxes and/or trays are fixed to the supporting frame.

Fixing multiple slotted plates and/or perforated plates allows the user of the vehicle body or of a motor vehicle containing the vehicle body to be able to secure or store objects, in particular tools or materials, on the rack unit in a wide variety of ways using the slotted plates and/or the perforated plates. In some embodiments, the rack unit extends transversely to the longitudinal axis of the vehicle body to receive multiple drawers and/or shelves and/or boxes and/or trays, or corresponding modules are provided or mounted on the rack unit. The rack unit can be loaded as a result.

In some embodiments, at least one of the fastening profiles is in the form of a deformable holder, which is suitable for absorbing energy in the event of an accident, or in the form of a damper.

In some embodiments, at least one of the fastening profiles, such as multiple fastening profiles, are in the form of a deformable holder or a damper. Forces and energy can therefore be absorbed in the event of an accident.

In some embodiments, the supporting frame is in the form of a peripheral frame.

The form of a peripheral or closed frame has stability. A peripheral frame can also be connected to the pillars of the vehicle body or further load-bearing vehicle body elements.

In some embodiments, the supporting frame has at least two vertically extending support elements and also an upper horizontally extending support element and a lower horizontally extending support element.

In some embodiments, the supporting frame has at least or exactly two vertically extending support elements which are positioned adjacently to at least one pillar of the motor vehicle. In some embodiments, the supporting frame has a lower horizontally extending support element which extends preferably adjacently to, preferably is directly next to, the floor of the vehicle body or the vehicle floor. Furthermore, in some embodiments, the supporting frame has an upper horizontally extending support element which extends adjacently to a roof strut of the vehicle body. The roof strut may be a roof strut which is connected at its ends to the pillars, such as the B pillars, of the vehicle body to which the supporting frame is fixed. The upper horizontally extending support element may optionally be formed in multiple parts or have angled portions or bends, in particular in order to follow a profile of the roof strut or the roof or a roof inclination. In this case, it may be provided that the upper horizontally extending support element has a center part which extends horizontally and two end portions which extend with a downward inclination from the center part.

In some embodiments, the supporting frame has at least one horizontally extending crossbeam which extends between the upper support element and the lower horizontal support element.

To increase the stability, in some embodiments, the supporting frame additionally has at least one horizontally extending crossbeam, such as exactly one horizontally extending crossbeam. Such an embodiment has been found to be suitable in terms of weight optimization and the highest possible stability. The crossbeam may extends parallel to the lower and the upper support element.

In some embodiments, if the crossbeam extends in the upper third of the height of the supporting frame.

Arranging the crossbeam in the upper third has been found to be suitable for stability reasons. Arranging the crossbeam in the upper third of the height of the supporting frame also does not adversely affect the provision of drawers, boxes or trays in the lower region of the supporting frame to form the rack unit.

The disclosure may also provide that the periphery of the supporting frame at least approximately has a profile which corresponds to the inner periphery of a cross section through an interior space of the vehicle body in the region between the driver's cab and the loading space.

Such a profile of the periphery of the supporting frame has been found to be suitable.

In some embodiments, the supporting frame is offset, from the B pillars of the vehicle body, rearwardly in the direction toward the loading space along the longitudinal axis of the vehicle body, the supporting frame being detachable connected in the region of its lower end to the adjacent B pillar respectively via one of the fastening profiles.

Attaching the supporting frame to the B pillars using fastening profiles has been found to be suitable, in particular in order to offset the supporting frame rearward along the longitudinal axis of the vehicle body. In this case, the supporting frame is set back from the longitudinal position of the B pillars along the longitudinal axis of the vehicle body by 10 cm to 50 cm. This results in enough space to provide drawers, trays, boxes and the like of the rack unit. The positioning of the partition wall is also optimized.

In some embodiments, the supporting frame is connected in the region of its upper end to a roof strut, extending between the two B pillars, of the vehicle body via at least two of the fastening profiles.

In some embodiments, the supporting frame is connected in the region of its upper end to a roof strut of the vehicle body via at least two of the fastening profiles. It may be provided in this case that the fastening profiles each have two struts, with the result that each fastening profile is arranged on the supporting frame at two locations, the two struts meeting at a point where a connection to the roof strut is then established. The ends of the struts that point toward the supporting frame may be connected to one another via a further strut. The fastening profiles may span a triangle.

The disclosure may also provide that the cladding is formed in multiple parts, such as two parts, an upper cladding part and a lower cladding part being designed and arranged on the supporting frame such that the upper cladding part at least partially extends further into the loading space than the lower cladding part.

In some embodiments, the cladding is formed in multiple parts, such as two parts, as described above. As a result, an additional space in the passenger compartment is made available in the region of the backrest of the seats and can be used to incline or fold back the backrest rearwardly.

In some embodiments, the cladding is made from steel, aluminum, plastic or a composite material.

In some embodiments, the material from which the cladding is made attenuates sound.

The disclosure may also provide that the support elements are in the form of polygonal profiles, such as square profiles.

The support profiles being in the form of polygonal profiles results in high stability and makes it possible to produce them relatively easily. The cross section of the polygonal profiles may be rectangular, in particular substantially square. The polygonal profiles may be in the form of extruded profiles. The polygonal profiles may optionally have hole systems which can serve as fastening points and/or for securing loads.

In some embodiments, at least one of the support elements has an airline hole system for securing loads.

The lower horizontally extending support element is provided with or has an airline hole system.

In some embodiments, the two vertically extending support elements also have an airline hole system or are provided with an airline hole system, such as at least along some of their height, such as over the entire height.

In some embodiments, only the lower horizontally extending support element has an airline hole system and the two vertically extending support elements have holes or holes arranged in a grid which serve for screw-fastening of modules of the rack unit and/or the cladding of the partition wall. The upper horizontally extending support element does not have any holes for screw-fastening of modules or an airline hole system. In some embodiments, the optionally provided crossbeam does not have any holes or an airline hole system.

The disclosure may also provide that the partition wall and the rack unit together are in the form of a self-supporting system.

Within the context of the disclosure, it is possible to provide further rack units, in particular also rack units positioned with an extent in the longitudinal direction of the vehicle body. A further rack unit is provided at least on a longitudinal side or longitudinal wall, in particular on a longitudinal side, which does not have any doors. The end face or the region of the end face of the further rack unit may be connected to the rack unit according to the disclosure or to the common supporting frame of the partition wall and the rack unit, in particular to one of the vertically extending support elements of the supporting frame.

One or more of the fastening means used to fix the cladding of the partition wall to the supporting frame and/or the roof strut may also be used to fasten accessories, such as clothes hooks, to that side of the cladding that faces toward the driver's cab.

The vehicle body according to the disclosure may have a rear door, a door which leads into the loading space additionally also being provided in one of the longitudinal sides.

The vehicle interior fitting of the disclosure has a partition wall, which is suitable for separating a loading space and a driver's cab of a motor vehicle at least approximately completely from one another. The vehicle interior fitting according to the disclosure also has a rack unit, which extends adjacently to the partition wall. The disclosure provides that the partition wall and the rack unit have a common supporting frame.

Such a vehicle interior fitting can be installed in a motor vehicle or in a body of a motor vehicle.

As regards further configurations, reference is hereby explicitly made to the statements made above in relation to the vehicle body according to the disclosure.

In some embodiments, a cladding, which separates the loading space and the driver's cab from one another, of the partition wall is fixed to the supporting frame directly and/or via profile elements, and at least one module of the rack unit is fixed to the supporting frame directly and/or via profile elements.

In some embodiments, if the at least one module is in the form of a drawer, box, tray, shelf, worktop, wall cladding, wall cabinet, tool cabinet, slotted plate, perforated plate, or receptacle for a toolbox.

The disclosure can also provide that the supporting frame is in the form of a peripheral frame.

In some embodiments, if the supporting frame has at least two vertically extending support elements and also an upper horizontally extending support element and a lower horizontally extending support element.

The disclosure may also provide that the supporting frame has at least one horizontally extending crossbeam, which extends between the upper support element and the lower support element, the crossbeam extending in the upper third of the height of the supporting frame.

In some embodiments, the support elements are in the form of polygonal profiles, such as square profiles, and at least one of the support elements has an airline hole system for securing loads.

The present disclosure also relates to a motor vehicle according to one of the embodiments described above, and/or having a loading space and a driver's cab separated from one another by a vehicle interior fitting according to one of the embodiments described above.

Features which have been described in connection with one of the subjects of the disclosure, specifically in the form of the vehicle body according to the disclosure, the vehicle interior fitting according to the disclosure or the motor vehicle according to the disclosure, can also be advantageously implemented for the other subjects of the disclosure. Similarly, embodiments that have been mentioned in connection with one of the subjects of the disclosure can also be understood as relating to the other subjects of the disclosure.

In addition, it should be pointed out that terms such as “comprising”, “having” or “with” do not exclude any other features or steps. Furthermore, terms such as “a”, “an” or “the” which refer to a single number of steps or features do not exclude multiple features or steps, and vice versa.

A puristic embodiment of the disclosure, however, may also provide that the features introduced in the disclosure by the terms “comprising”, “having” or “with” constitute an exhaustive list. Accordingly, within the context of the disclosure, one or more lists of features may be considered as self-contained, for example respectively for each claim.

It should be mentioned that designations such as “first” or “second” etc. are used primarily for the purposes of being able to make a distinction between respective device or method features and are not necessarily intended to indicate that features require one another or are related to one another.

Exemplary embodiments of the disclosure will be described in more detail below with reference to the drawing.

The figures each show exemplary embodiments in which individual features of the disclosure are illustrated in combination with one another.

Features of one exemplary embodiment can also be implemented in isolation from the other features of the same exemplary embodiment and can accordingly be readily combined with features of other exemplary embodiments by those skilled in the art to form further expedient combinations and sub-combinations.

Elements that have the same function are provided with the same reference signs in the figures.

### DESCRIPTION OF DRAWINGS

FIG. 1 shows a perspective sectional illustration through a body of a motor vehicle having a loading space and a driver's cab, which is indicated in dashed lines;

FIG. 2 shows an illustration according to FIG. 1, with fastening profiles being fixed to a B pillar;

FIG. 3 shows a perspective front view of a body of a motor vehicle, with a supporting frame being connected to the two B pillars of the vehicle body via fastening profiles;

FIG. 4 shows a perspective view according to FIG. 2, with a supporting frame being fixed to the two B pillars and a roof strut of the vehicle body using fastening profiles;

FIG. 5 shows a further illustration of the installation situation according to FIG. 4 from a different viewing direction, of the vehicle body only the roof strut being illustrated;

FIG. 6 shows an illustration according to FIG. 4, with a module (perforated plate) of a rack unit being fixed to the supporting frame and additionally the installation of a part of the partition wall (upper cladding part) being symbolically shown;

FIG. 7 shows an illustration according to FIG. 6, with additional illustration of a further part of the partition wall (lower cladding part) and, in a side view, both cladding parts of the partition wall;

FIG. 8 shows an illustration according to FIG. 7, with both cladding parts of the partition wall and further modules (perforated plate/wall cladding) of the rack unit being mounted on the supporting frame;

FIG. 9 shows an illustration according to FIG. 8, with a basic structure of a further rack unit, which extends in the longitudinal direction of the vehicle body, being assembled;

FIG. 10 shows a perspective illustration of a supporting frame with a fully assembled rack unit and a partition wall, or a perspective illustration of a vehicle interior fitting illustrating a B pillar of the vehicle body;

FIG. 11 shows a plan view of one embodiment of a supporting frame; and

FIG. 12 shows a two-part embodiment of a cladding of a partition wall according to FIG. 7.

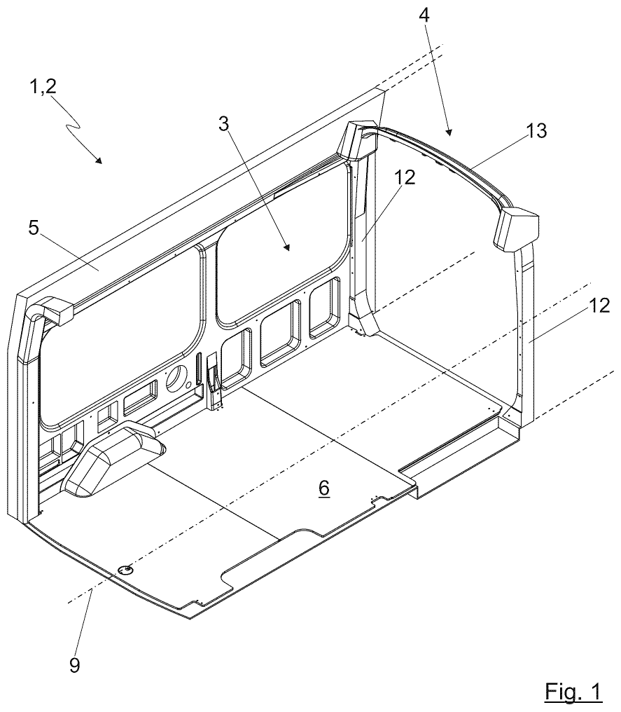

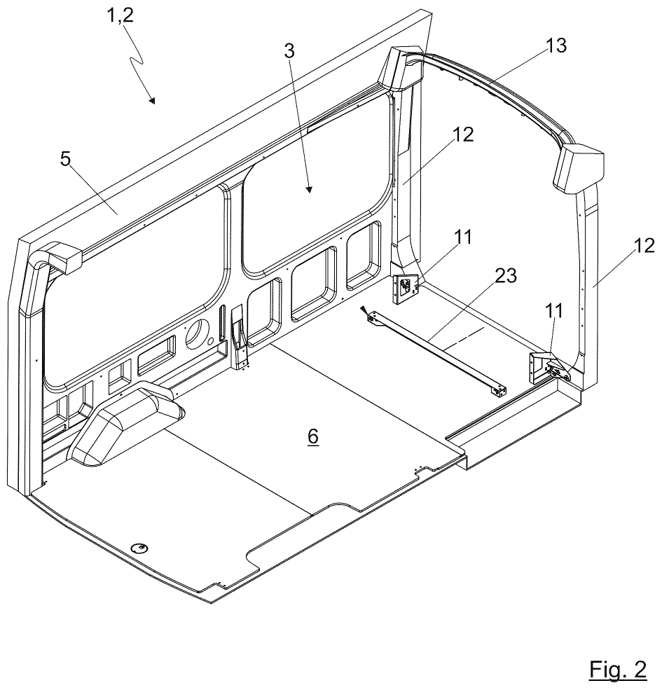

FIG. 1 shows a vehicle body 1 of a motor vehicle 2, otherwise not illustrated in more detail, having a loading space 3 and a driver's cab 4, which is illustrated only in dashed lines. The driver's cab 4 is illustrated only in FIG. 1, but is also correspondingly present in FIGS. 2, 3 and 4 to 9.

The vehicle body 1 illustrated in the figures has, as illustrated, a rear door opening and in some embodiments, additionally a side door opening, which are not denoted any more specifically in an exemplary embodiment. In some embodiments, there is both a rear door opening and a side door opening.

The figures illustrate one of the longitudinal sides 5 of the vehicle body 1, and a vehicle floor 6.

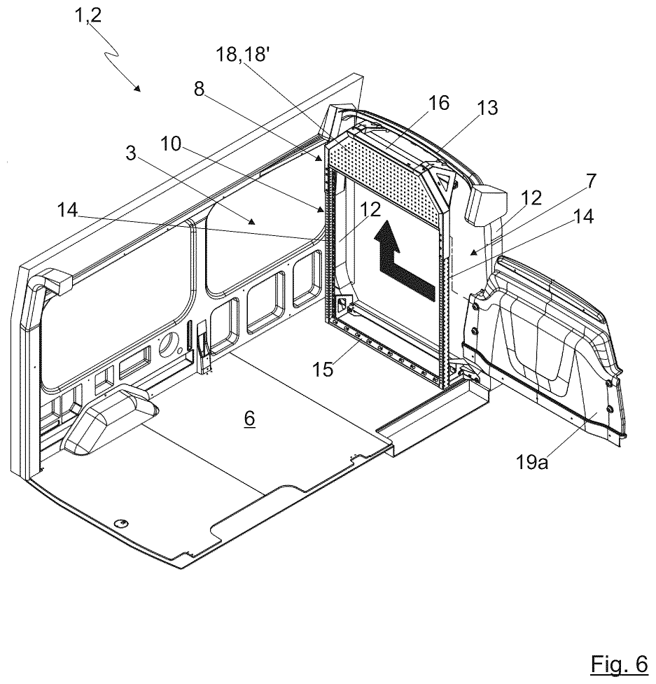

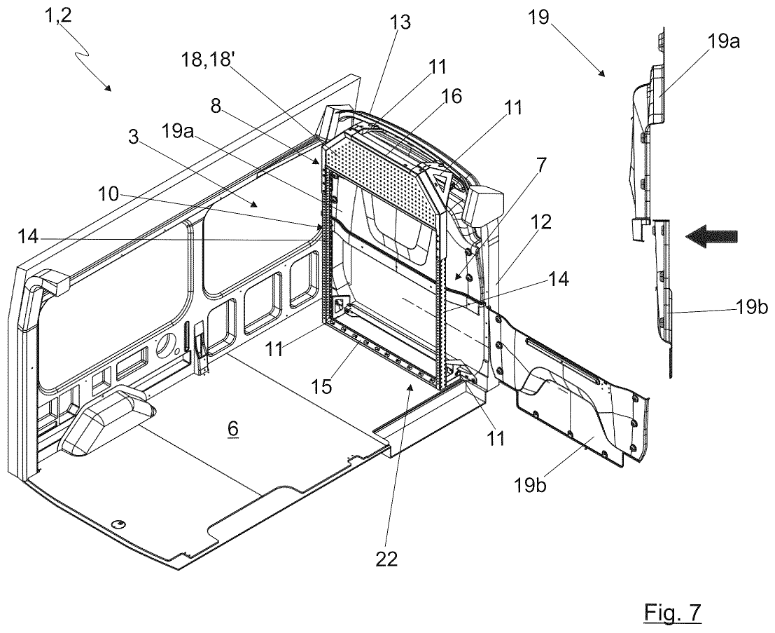

The vehicle body 1 according to the disclosure, or the motor vehicle 2, has a partition wall 7 and a rack unit 8. The loading space 3 and the driver's cab 4 are separated from one another by the partition wall 7. This is shown in particular in FIGS. 7 to 9. The rack unit 8 is arranged in the loading space 3 and extends, adjacently to the separating wall 7, transversely to a longitudinal axis 9 of the vehicle body 1 (see FIG. 1). The rack unit 8 thus extends parallel to a transverse axis, not denoted any more specifically, of the vehicle body 1. This is correspondingly shown in FIGS. 6 to 10, which show different development stages of the rack unit 8.

The partition wall 7 and the rack unit 8 have a common supporting frame 10, which can be fixed to at least one pillar 12 of the vehicle body 1 directly and/or via fastening profiles 11.

FIGS. 1 to 10 show different development stages, or installation situations, of the supporting frame 10, the partition wall 7 and the rack unit 8.

An exemplary embodiment provides that the supporting frame 10 is fixed to at least one pillar 12 of the vehicle body 1 via fastening profiles 11.

In an exemplary embodiment, the supporting frame 10 is fixed to the at least one pillar 12 by a detachable connection or a conditionally detachable connection. A screw connection or a connection using rivets is provided.

An exemplary embodiment provides that the supporting frame 10 is fixed to two pillars 12 of the vehicle body 1, which are provided on oppositely situated longitudinal sides 5 of the vehicle body 1. The pillars 12 are on the oppositely situated longitudinal walls, or longitudinal sides 5, of the vehicle body 1 at the same position with respect to the longitudinal axis 9. An exemplary embodiment provides that the pillars 12 are the B pillars of the vehicle body 1.

An exemplary embodiment provides, in addition to fixing the supporting frame 10 to the B pillars 12, that the supporting frame 10 is also fixed to a roof strut 13 of the vehicle body 1, such as via fastening profiles 11. This roof strut 13 is one which extends between the two B pillars 12 or is fixed to the upper ends of the two B pillars 12.

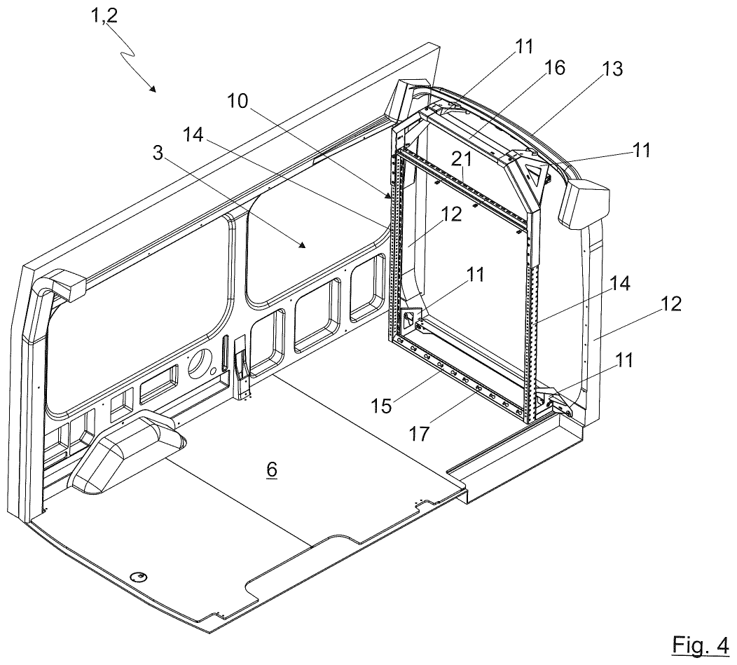

As illustrated in particular in FIGS. 4 and 6 to 10, the supporting frame 10 is connected in the region of its upper end to the roof strut 13 via at least two of the fastening profiles 11. The illustrated form of the fastening profiles 11 that are used for this purpose, as emerges from the figures, has been found to be suitable for this.

The supporting frame 10 may be formed differently, for example have an L shape or a U shape. It is also possible for the supporting frame 10 to consist only, or substantially, of two vertically extending support elements, which extend adjacently and at least partially parallel to the B pillars 12.

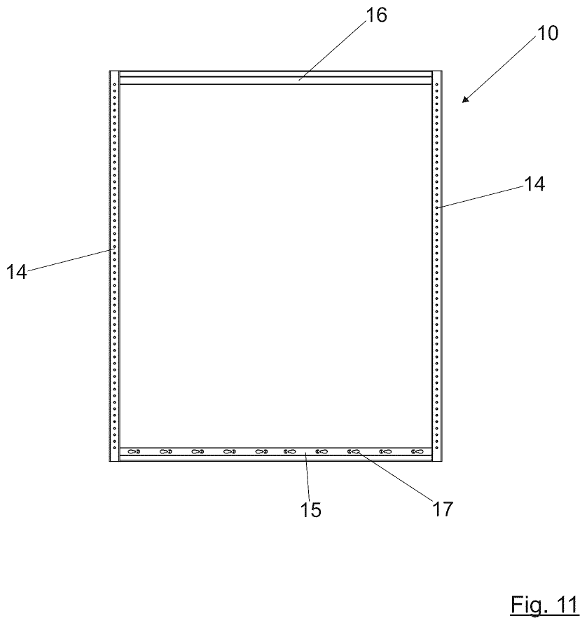

An exemplary embodiment illustrates a configuration of the supporting frame 10 as a closed or peripheral frame. The supporting frame 10 may be configured as illustrated in FIG. 11. For this, the supporting frame 10 may have, for example, a height of 1400 mm to 2000 mm, in particular 1450 mm to 1900 mm, or such as 1450 mm to 1600 mm.

The width of the supporting frame 10 may be 1000 mm to 1600 mm, such as 1100 mm to 1500 mm, or such as 1200 to 1400 mm.

Both the length and the height of the supporting frame 10 may depend on the dimensions of the interior space of the vehicle body 1, in particular in the region between the loading space 3 and the driver's cab 4.

The supporting frame 10 has at least two vertically extending support elements 14 and also an upper horizontally extending support element 15 and a lower horizontally extending support element 16. This is illustrated by way of

[symbol]

[symbol] example in FIG. 11. The support elements 14, 15, 16 may be in the form of polygonal profiles, such as square profiles, or be formed with a rectangular, in particular square cross section. In some embodiments, at least one of the support elements 14, 15, 16 has an airline hole system 17 for securing loads. Providing an airline hole system 17 on the lower horizontally extending support element 15, as illustrated in the figures, in particular also FIG. 11, is suitable.

As an alternative to providing an airline hole system 17, it is also possible to provide another hole system for receiving load securing elements.

The lower support element 15 extends next to the vehicle floor 6. The lower support element 15 may be fastened, such as screw-fastened, to the vehicle floor 6.

In some embodiments, the vertically extending support elements 14 have bores, holes or hole systems arranged in a grid and intended for fixing, for detachable fixing, of modules 18 of the rack unit 8 and/or for fixing of fastening profiles 11. The holes may also be provided in order to fix elements of the partition wall 7, in particular the cladding 19 of the partition wall 7.

The holes in the vertically extending support elements 14 extend over the entire height of the support elements 14, but may also extend only over some of the height.

A cladding 19, which separates the loading space 3 and the driver's cab 4 from one another, of the partition wall 7 may be fixed to the supporting frame 10 directly and/or via profile elements 20. Modules 18 of the rack unit 8 may also be fixed to the supporting frame 10 directly or via profile elements 20.

The modules 18 of the rack unit 8 may take a wide variety of embodiments, such as in the form of drawers, boxes, trays, shelves, worktops, wall claddings, wall cabinets, tool cabinets, slotted plates, perforated plates, or receptacles for a toolbox.

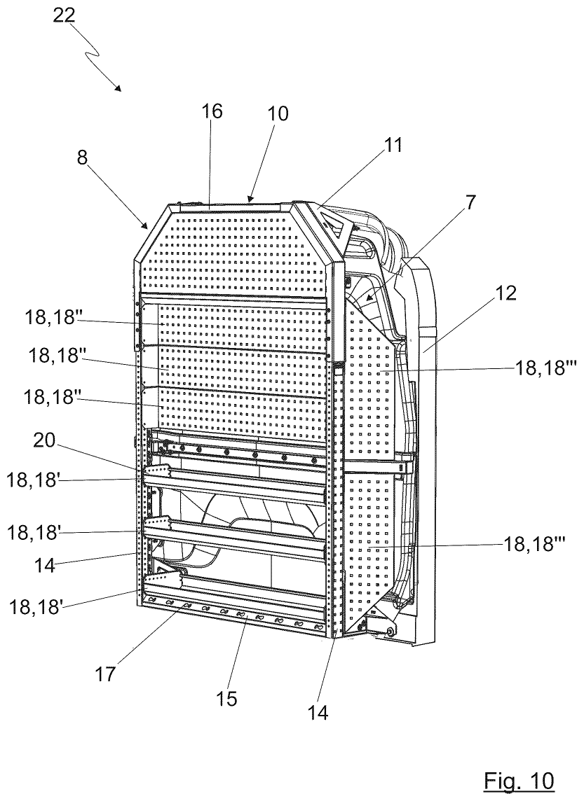

An exemplary embodiment illustrates different forms the modules 18 can take, reference being made in this respect in particular to the exemplary form of the rack unit 8 according to FIG. 10.

In FIG. 10, three modules 18 in the form of trays 18′ are illustrated in the lower region of the rack unit 8. Four modules 18 in the form of perforated plates 18″ are mounted above the modules 18 in the form of trays 18′. Furthermore, two modules 18 are in the form of wall claddings 18′″ which, in an exemplary embodiment, also have a perforated structure, i.e. can serve as perforated plates.

The illustration according to FIG. 10 is exemplary in the present case. The rack unit 8 can be loaded with modules 18 as desired, and in some embodiments drawers, boxes, trays 18′, shelves or worktops or else receptacles for toolboxes are provided in the lower region of the rack unit 8, i.e. in the lower half of the rack unit 8. The upper half of the rack unit 8, or the upper region of the rack unit 8, is suitable for providing or fixing slotted plates, perforated plates 18″ or wall claddings 18′″ there. In some embodiments, multiple slotted plates and/or perforated plates 18″ are fixed to or provided on the supporting frame 10. In some embodiments, if multiple drawers and/or shelves and/or boxes and/or trays 18′ are fixed to the rack unit 8.

The profile elements 20 that can serve for fixing the modules 18 or the cladding 19 may be, for example, metal sheets, brackets or side parts. In FIG. 10, by way of example, one side part is provided with the reference sign 20 as an example of a profile element. The modules 18 and the cladding 19 may also be connected to the supporting frame 10 directly, such as by means of a screw connection.

The cladding 19 of the partition wall 7 may be formed in one piece or multiple parts. An exemplary embodiment provides that the cladding 19 is formed in two parts. The cladding 19 has an upper cladding part 19a and a lower cladding part 19b. The cladding parts 19a and 19b of the cladding 19 are correspondingly illustrated in FIGS. 6 to 10 and FIG. 12. FIGS. 6 and 7 show an assembly of the cladding parts 19a, 19b.

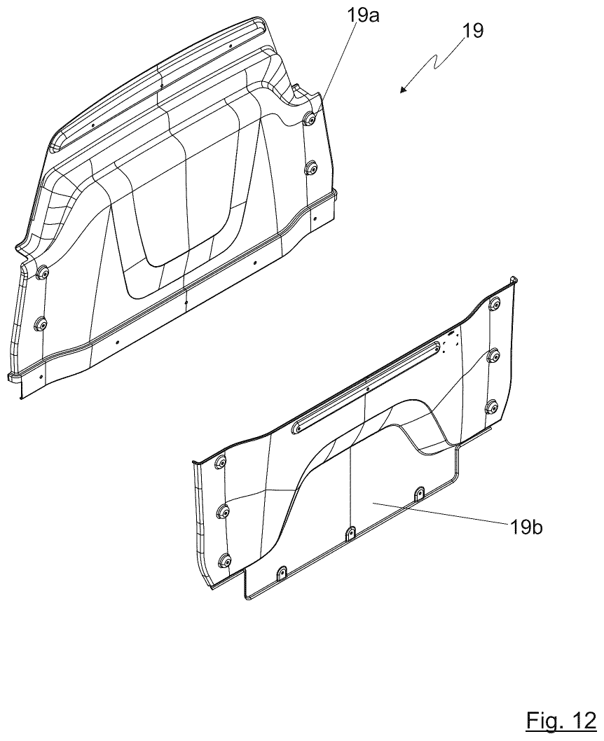

An exemplary embodiment provides that the upper cladding part 19a and the lower cladding part 19b are arranged or provided on the supporting frame 10 such that the upper cladding part 19a at least partially extends further into the loading space 3 than the lower cladding part 19b. This is visible in FIG. 7 and also in FIG. 12. FIGS. 7 and 12 show a structural configuration of the cladding 19 with the two cladding parts 19a and 19b.

The cladding 19 may for example be produced from steel, aluminum, plastic or a composite material.

An exemplary embodiment may provide that at least one of the fastening profiles 11 is in the form of a deformable holder, which is suitable for absorbing energy in the event of an accident, or in the form of a damper, or is formed with a damper. An exemplary embodiment may provide that all the fastening profiles 11 are formed correspondingly.

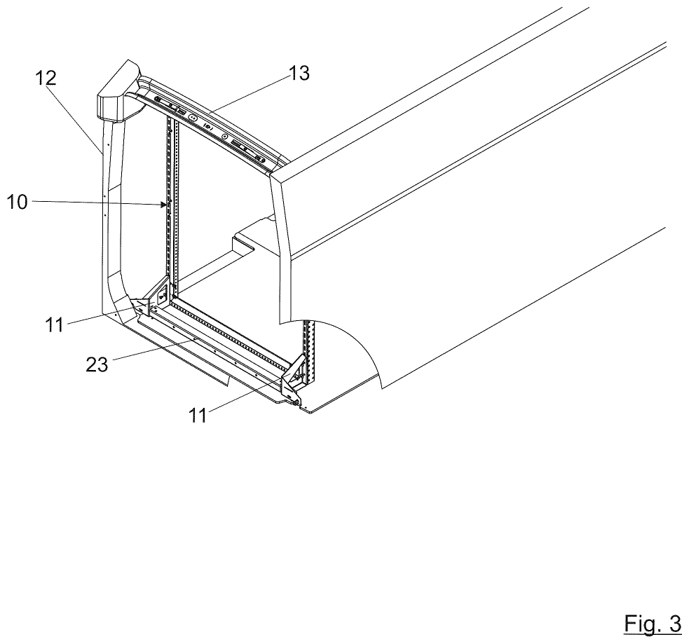

As already mentioned, the supporting frame 10 may be formed as illustrated in FIG. 11. Further development elements or support elements may be mounted on the supporting frame 10. FIGS. 3 to 10 illustrate an embodiment of the supporting frame 10 in which the periphery of the supporting frame 10 at least approximately has a profile which corresponds to the inner periphery of a cross section through an interior space of the vehicle body 1 in the region between the driver's cab 4 and the loading space 3. The upper, horizontally extending support element 16 has a horizontally extending center part, or center portion, for this. Next to the center part there are two end portions or end regions which extend with a downward inclination from the center part, with the result that the shape of a roof or the roof strut 13 of the vehicle body 1 can be at least approximately reproduced. The supporting frame 10 according to FIGS. 3 to 10 therefore does not have a strictly rectangular shape, but rather is sloped or inclined at the two upper ends. To increase the stability, it is possible in this case, as illustrated in FIGS. 3 to 10, to provide at least one horizontally extending crossbeam 21, which extends between the upper support element 16 and the lower support element 15. The crossbeam 21 extends in the upper third of the height of the supporting frame 10.

It should be pointed out that, as already mentioned, the supporting frame 10 can also simply be configured as illustrated in FIG. 11. A formation of the supporting frame 10 as illustrated in FIGS. 3 to 10, however, is especially suitable in order to adapt the supporting frame 10 to an interior space of the vehicle body 1 or the motor vehicle 2. It is also possible, taking as a starting point the supporting frame 10 as illustrated in principle in FIG. 11, to fix or fit a structure or fastening profile 11, via which a connection is then established with the vehicle body 1, with a roof strut 13 of the vehicle body 1, on the supporting frame 10, which is to say at the upper end of the vertically extending support elements 14 and of the upper support element 16.

The supporting frame 10 according to FIG. 11 can therefore also form the basis for a development as illustrated in FIGS. 3 to 10. In this case, the transverse strut 21 then corresponds to the upper support element 16 according to FIG. 11.

An exemplary embodiment provides that the supporting frame 10 is offset, from the B pillars 12 of the vehicle body 1, rearwardly in the direction toward the loading space 3 along the longitudinal axis 9 of the vehicle body 1 somewhat, such as 10 cm to 50 cm, the supporting frame 10 being detachably connected in the region of its lower end to the adjacent B pillar 12 respectively via one of the fastening profiles 11.

FIGS. 6 to 10 show various development stages for providing the vehicle body 1 with a partition wall 7 and a rack unit 8, or for equipping a vehicle body 1 or a motor vehicle 2 with a vehicle interior fitting 22 having a partition wall 7 suitable for at least approximately completely separating a loading space 3 and a driver's cab 4 of

[symbol]

[symbol] a motor vehicle 2, the vehicle interior fitting 22 also having a rack unit 8, which extends adjacently to the partition wall 7, and the partition wall 7 and the rack unit 8 having a common supporting frame 10.

An exemplary embodiment correspondingly also serves to disclose a vehicle interior fitting 22, or is to be understood correspondingly.

An exemplary embodiment furthermore also serves to disclose a motor vehicle 2, such as a utility vehicle, having a vehicle body 1 according to the disclosure, or having a loading space 3 and a driver's cab 4 separated from one another by a vehicle fitting 22.

FIG. 1 shows the vehicle body 1 without a partition wall 7 or a rack unit 8.

FIG. 2 shows that a respective fastening profile 11 is fixed to each of the B pillars 12. FIG. 11 also illustrates a transverse profile 23 which serves to stabilize the fastening profiles 11 further.

FIG. 3 shows that a supporting frame 10 is fixed to the fastening profiles 11.

FIG. 4 shows the supporting frame 10 in an embodiment with a crossbeam 21 and with further fastening elements 11, which are used to fix the supporting frame 10 to the roof strut 13 of the vehicle body 1.

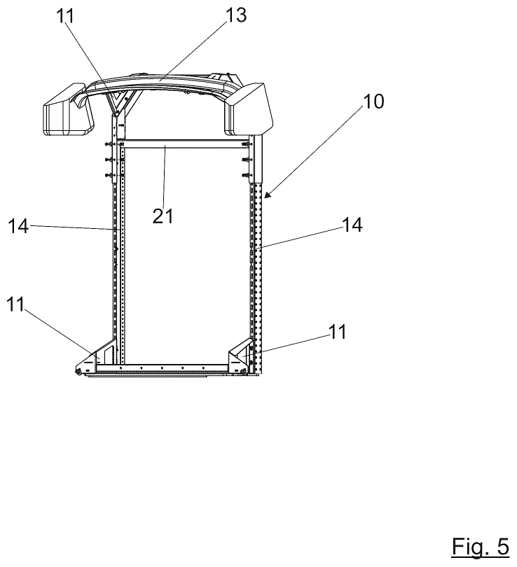

FIG. 5 shows an illustration similar to FIG. 4 from a different viewing direction, of the vehicle body 1 only the roof strut 13 being illustrated.

FIG. 6 shows that a module 18 of the rack unit 8 is already assembled on the supporting frame 10 in the upper region, the module 18 being a perforated plate 18″. FIG. 6 also shows how an upper cladding part 19a can be assembled.

FIG. 7 shows how a lower cladding part 19b can be assembled.

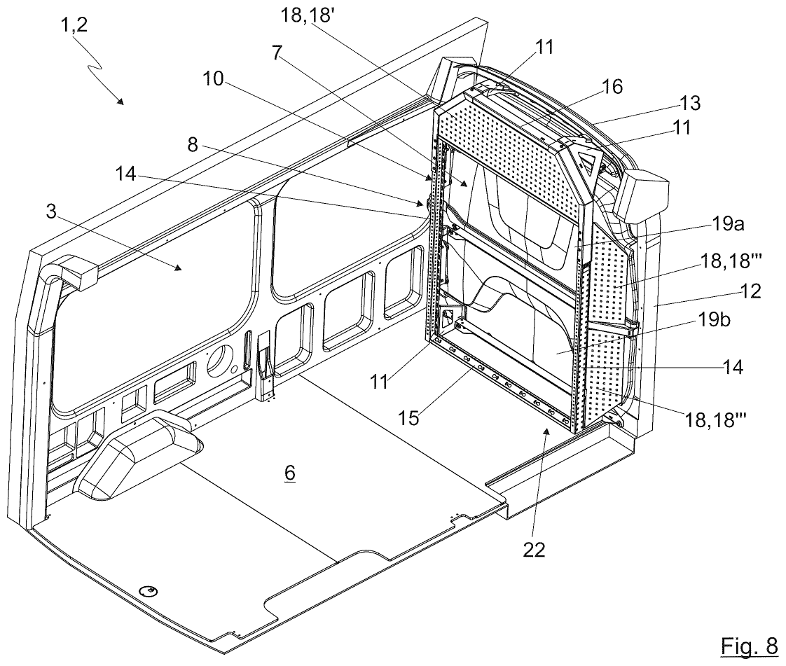

FIG. 8 shows how the cladding 19 of the partition wall 7 is fully assembled, or fixed to the supporting frame 10. The cladding 19 shuts off the loading space 3 completely from the driver's cab 4.

FIG. 8 also shows that two further modules 18, which are wall cladding parts 18′″, are assembled.

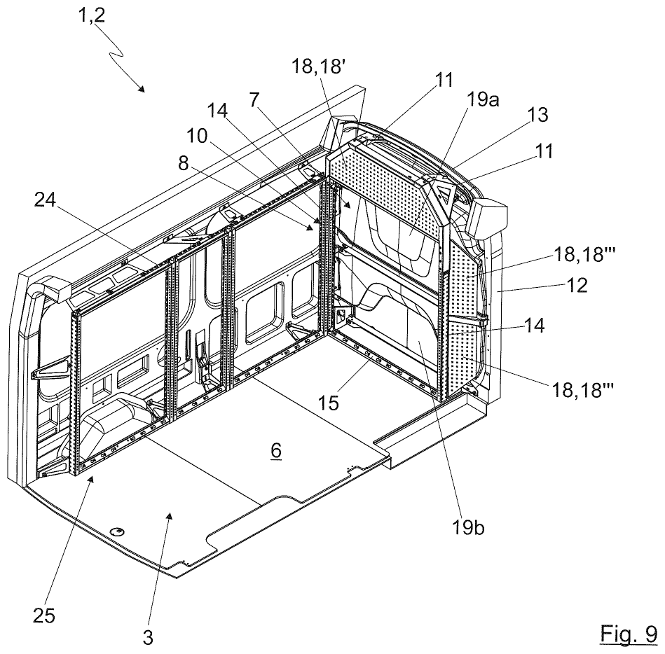

FIG. 9 shows a basic structure 24 of a further rack unit 25, which extends along the longitudinal side 5 and thus along the longitudinal axis 9. The further rack unit 25, or its basic structure 24, which may among other things be a supporting frame, is connected, such as screw-fastened, to the supporting frame 10, such as to one of the support elements 14 of the supporting frame 10.

The rack units 8 and 25 may be part of a rack system which is installed in the vehicle body 1 of the motor vehicle 2. Yet further rack units can also be added.

FIG. 10 shows, by way of example, an structure of the partition wall 7 and of the rack unit 8, which have a common supporting frame 10 and together form a vehicle interior fitting 22. Also illustrated is another one of the B pillars 12 of the vehicle body 1.

1. A vehicle body, comprising:
a loading space;
a driver's cab; and
a partition wall and a rack unit;
wherein the loading space and the driver's cab are separated from one another by the partition wall, and wherein the rack unit is arranged in the loading space and extends adjacently to the partition wall, and transversely to a longitudinal axis of the vehicle body; and
wherein the partition wall and the rack unit have a common supporting frame, and the common supporting frame is fixed to at least one pillar of the vehicle body.

2. The vehicle body according to claim 1, wherein the common supporting frame is detachably fastened to the at least one pillar.

3. The vehicle body according to claim 1, wherein the common supporting frame is fixed to two pillars of the vehicle body, which are provided on oppositely situated longitudinal sides of the vehicle body.

4. The vehicle body according to claim 1, wherein the at least one pillar is a B pillar of the vehicle body.

5. The vehicle body according to claim 1, further comprising a cladding of the partition wall that separates the loading space and the driver's cab from one another and is fixed to the common supporting frame by one of a direct connection or one or more profile elements; and wherein at least one module of the rack unit is fixed to the common supporting frame by one of a direct connection or one or more profile elements.

6. The vehicle body according to claim 5, wherein the at least one module is one of a drawer, box, tray, shelf, worktop, wall cladding, wall cabinet, tool cabinet, slotted plate, perforated plate, or receptacle for a toolbox.

7. The vehicle body according to claim 6, wherein the at least one module comprises one of multiple slotted plates, multiple perforated plates, multiple drawers, multiple shelves, multiple boxes, or multiple trays fixed to the common supporting frame.

8. The vehicle body according to claim 1, wherein the common supporting frame is fixed to at least one pillar of the vehicle body via one or more fastening profiles, and at least one of the one or more fastening profiles is one of a deformable holder or a damper.

9. The vehicle body according to claim 1, wherein the common supporting frame is a peripheral frame.

10. The vehicle body according to claim 1, wherein the common supporting frame has at least two vertically extending support elements, and also an upper horizontally extending support element and a lower horizontally extending support element.

11. The Vehicle body according to claim 1, wherein the common supporting frame has at least one horizontally extending crossbeam, which extends between an upper support element and a lower support element.

12. The vehicle body according to claim 11, wherein the at least one horizontally extending crossbeam extends between an upper third portion of the common supporting frame.

13. The vehicle body according to claim 1, wherein a periphery of the common supporting frame has a profile which corresponds at least approximately to an inner periphery of a cross section through an interior space of the vehicle body in a region between the driver's cab and the loading space.

14. The vehicle body according to claim 4, wherein the common supporting frame is offset, from the B pillar of the vehicle body, rearwardly in a direction toward the loading space along a longitudinal axis of the vehicle body, the common supporting frame being detachably connected in a region of its lower end to the B pillar via one or more fastening profiles.

15. The vehicle body according to claim 4, wherein an upper end portion of the common supporting frame is connected to a roof strut extending between two B pillars, via at least two fastening profiles.

16. The vehicle body according to claim 5, wherein the cladding is formed as an upper cladding part and a lower cladding part being arranged on the common supporting frame such that the upper cladding part at least partially extends further into the loading space than the lower cladding part.

17. The vehicle body according to claim 5, wherein the cladding is made from steel, aluminium, plastic or a composite material.

18. The vehicle body according to claim 10, wherein the at least two vertically extending support elements are polygonal profiles.

19. The vehicle body according to claim 10, wherein at least one of the at least two vertically extending support elements has an airline hole system for securing loads.

20. The vehicle body according to claim 1, wherein the partition wall and the rack unit together are form a self-supporting system.

21. A vehicle interior fitting, comprising:
a partition wall, which is suitable for separating a loading space and a driver's cab of a motor vehicle at least approximately completely from one another and
a rack unit, which extends adjacently to the partition wall, wherein the partition wall and the rack unit have a common supporting frame.

22. The vehicle interior fitting according to claim 21, further comprising a cladding of the partition wall that separates the loading space and the driver's cab from one another wherein the cladding is fixed to the common supporting frame by one of a direct connection or via one or more profile elements; and wherein and at least one module of the rack unit is fixed to the common supporting frame by one of a direct connection or one or more profile elements.

23. The vehicle interior fitting according to claim 22, wherein the at least one module is one of a drawer, box, tray, shelf, worktop, wall cladding, wall cabinet, tool cabinet, slotted plate, perforated plate, or receptacle for a toolbox.

24. The vehicle interior fitting according to claim 21, wherein the common supporting frame is a peripheral frame.

25. The vehicle interior fitting according to claim 21, wherein the common supporting frame has at least two vertically extending support elements, and also an upper horizontally extending support element and a lower horizontally extending support element.

26. The vehicle interior fitting according to claim 21, wherein the common supporting frame has at least one horizontally extending crossbeam, which extends between an upper support element and a lower support element, the at least one horizontally extending crossbeam extending across an upper third of a height of the common supporting frame.

27. The vehicle interior fitting according to claim 25, wherein the at least two vertically extending support elements have polygonal profiles and at least one of the at least two vertically extending support elements has an airline hole system for securing loads.
